(19) United States
(12) Patent Application Publication
(10) Pub. No.: US 2006/0230246 A1
(43) Pub. Date: Oct. 12, 2006

(54) Memory allocation technique using memory resource groups

(76) Inventors: Clifford J. Mather, San Jose, CA (US); Donald G. Morris III, Morgan Hill, CA (US); Arlie Stephens, Sunnyvale, CA (US); Anil Rao, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/102,077

(22) Filed: Apr. 8, 2005

(51) Int. Cl. G06F 12/00

(52) U.S. Cl. 711/170

(57) ABSTRACT

A method for managing memory usage in a computer system having a kernel and a kernel memory class. The method includes ascertaining a size of a base memory of the computer system, the base memory representing memory designated to be non-evacuable. The method also includes setting a size of the kernel memory class to be no larger than the size of the base memory. Requests for additional memory by a kernel process is evaluated at the evaluation stage and granted only if the additional memory, if granted, would not cause an amount of memory used by the kernel to exceed the size of the kernel memory class.

### RELATED APPLICATIONS

The present invention relates to the following commonly assigned applications, all of which are incorporated herein by reference.
“Physical Memory Control Using Memory Classes,” U.S. patent application Ser. No. 10/939,052, Attorney Docket No. 200405434-1, filed Sep. 10, 2004 by inventor Anil Rao; and
“Managing Shared Memory Usage within a Memory Resource Group Infrastructure,” U.S. patent application Ser. No. 10/939,047, Attorney Docket No. 200404691-1, filed Sep. 10, 2004 by inventor Anil Rao.

### BACKGROUND OF THE INVENTION

A computer system may sometimes have a need to evacuate the content of one or more pages of memory. For example, when it is suspected that a page of memory may be defective, it is desirable to remove that page of memory from use. As another example, in a computer with multiple partitions, it may be useful to assign a page of memory from one partition to another partition (for load balancing, for example). Since the page of memory to be removed or reassigned may be accessed by executing processes and/or devices, it is necessary to properly evacuate the content of the memory page so that such executing processes and/or devices can continue with minimal disruption vis-a-vis a new memory page.

To facilitate discussion, FIG. I shows an example computer system 102, including a CPU 104, an I/O module 106, and a memory module 108, all connected via a bus 110. Computer 102 is intended to be illustrative and is thus vastly simplified. In reality, computer 102 may represent a computer system with multiple CPUs, multiple I/O modules, multiple memory modules, and may have its components dispersed geographically among different enclosures. A bus-based architecture is also not a requisite feature of computer system 102.

Memory module 108 is typically implemented using some type of semiconductor memory for fast access. Within memory module 108, there are shown a plurality of pages A-L. In the example of FIG. 1, memory pages A, E, F, H, and K have contents stored in them. The contents in these memory pages A, E, F, H, and K may be utilized by processes executing using CPU 104, for example. Memory pages B, C, D, G, I, J, and L are shown to be free memory pages. Memory evacuation refers to the process of transferring or copying the content from a source memory page (e.g., the content from memory page A) to a destination memory page (e.g., memory page C) so that the source memory page can be freed up after the evacuation process is complete. For simplicity, the source memory page and the destination memory page belong to the same memory module in the example of FIG. 1. In fact, memory evacuation works even if memory pages are dispersed among different memory modules.

Memory evacuation also occurs quite frequently in the context of dynamically reconfigurable computer systems whereby a large pool of components (e.g., CPU's, IO's hard disks, etc.) are coupled together in a network of components, and various computer systems can be dynamically configured from this network of components. Dynamic reconfiguration systems include, for example, Solaris 10 from Sun Microsystems, Inc. of Mountain View, Calif. and AIX 5L from IBM Corporation.

When a new computer system is configured, efficient memory allocation for the newly configured computer system may require that memory already allocated be evacuated to free up the allocated memory, thereby enabling the new computer system to utilize the newly freed memory.

Some memory types may be simpler to evacuate or can be evacuated with more efficiency and less risk than other memory types. In the context of dynamically reconfigurable computer systems, for example, some operating systems allow the operator to specify upon configuring a given computer system which type of memory can be evacuated, which type of memory cannot be evacuated, and how much memory to allocate to each. For example, kernel memory may be designated as base memory (i.e., not subject to evacuation). On the other hand, some type of user (application) memory may be designated as floating memory (i.e., can be evacuated if needed) or as base memory. Thus, the total amount of memory granted to a computer system may be divided into at least base memory and floating memory.

Within a computer system, memory may also be allocated to a process as needed. For example, as an application executes its tasks, it may at times require more memory. In this case, additional memory needs to be allocated to the application to prevent the application from becoming blocked. Once the application completes a task, the memory that it no longer needs is de-allocated. The de-allocated memory is then freed and returned to the free memory pool. Kernel processes also need additional memory from time to time and additional memory may also be allocated to kernel processes as needed.

Suppose that all base memory had been used up in a given computer system, but there is plenty of free floating memory available. Furthermore, suppose that a kernel process now wishes to obtain more memory. Unfortunately, only floating memory is available as free memory. In this case, the allocation mechanism may refuse to allocate the free floating memory to the requesting kernel process since kernel processes require base memory. Without the required additional memory, that kernel process may be blocked after being denied the additional memory.

If there are enough blocked kernel processes, the likelihood of an undesirable result, such as a system deadlock, may occur. A system deadlock, as is known, occurs because one or more blocked kernel processes may hold a system-wide resource that is required by other kernel processes. On the other hand, if the allocation mechanism proceeds with the allocation of floating memory to the requesting kernel process, a subsequent evacuation of that floating memory may result in a system crash and/or other unstable system conditions. As can be appreciated, neither outcome is particularly desirable.

### SUMMARY OF INVENTION

The invention relates, in an embodiment, to a method for managing memory usage in a computer system having a kernel and a kernel memory class. The method includes ascertaining a size of a base memory of the computer system, the base memory representing memory designated to be non-evacuable. The method also includes setting a size of the kernel memory class to be no larger than the size of the base memory.

In another embodiment, the invention relates to an article of manufacture comprising a program storage medium having computer readable code embodied therein, the computer readable code being configured to manage memory usage in a computer system having a kernel and a kernel memory class. There is included computer readable code for ascertaining a size of a base memory of the computer system, the base memory representing memory designated to be non-evacuable. There is further included computer readable code for setting a size of the kernel memory class to be no larger than the size of the base memory.

In yet another embodiment, the invention relates to an arrangement for managing memory usage in a dynamically reconfigurable computer system having a kernel and a kernel memory class. The arrangement includes means for ascertaining a size of a base memory of the computer system, the base memory representing memory designated to be non-evacuable. The arrangement further includes means for setting a size of the kernel memory class to be no larger than the size of the base memory. The arrangement additionally includes means for granting additional memory to a kernel process that requests the additional memory if the additional memory, if granted to the kernel process, would not cause the amount of kernel memory usage by the kernel to exceed the size of the kernel memory class.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

To facilitate discussion, FIG. 1 shows an example computer system, including a CPU, an I/O module, and a memory module, all connected via a bus.

FIGS. 2A and 2B are logical diagrams illustrating the concept of the reservation phase and the allocation phase as they pertain to fulfilling requests for additional memory.

FIG. 3 illustrates the concept of a memory resource group.

FIG. 4 illustrates the concept of a memory resource class.

FIG. 5 shows, in accordance with an embodiment of the present invention, a block logic diagram of an example computer system in which the kernel process is constrained such that additional memory requests cannot be granted if such additional memory request by a kernel process would cause the resultant memory usage by the kernel to exceed the amount of base memory set.

FIG. 6 shows, in accordance with an embodiment of the present invention, a method for configuring the computer system such that the kernel process is prevented from being allocated floating memory.

FIG. 7 shows, in accordance with an embodiment of the present invention, the steps taken to ensure that a kernel process is not granted floating memory in response to a request for additional kernel memory.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described hereinbelow, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One of the challenges in configuring a computer system, especially in the context of configuring a dynamically reconfigurable computer system, pertains to the need to allocate adequate base memory to accommodate kernel memory requirements since base memory cannot be evacuated at a later time. If too much of the total memory assigned to a given computer system is designated base memory to minimize the likelihood that floating memory is allocated to a kernel process, flexibility in the evacuation of memory suffers since little floating memory is left for evacuation should a need to evacuate arise later. Evacuation, as discussed, is at times useful, and some reasonable degree of flexibility with respect to the ability to evacuate memory allows computer systems to be efficiently configured and/or reconfigured.

If too little of the total memory assigned to a given computer system is designated base memory, the risk of memory starvation for kernel processes increases. The challenge is thus finding a mechanism to ensure that the kernel processes will not be allocated floating memory. Furthermore, it is preferable that the mechanism be simple, requiring little additional coding and introducing few complexities into the current computer software and/or hardware architectures.

It is realized by the inventors that a technique may be developed, utilizing two existing mechanisms, to ensure that the kernel processes will not be allocated floating memory. Embodiments of the invention lie in the identification of the problem, and/or the identification of existing mechanisms as well as the technique to utilize the existing mechanisms to solve the problem. Each of the mechanisms will be discussed in turn herein.

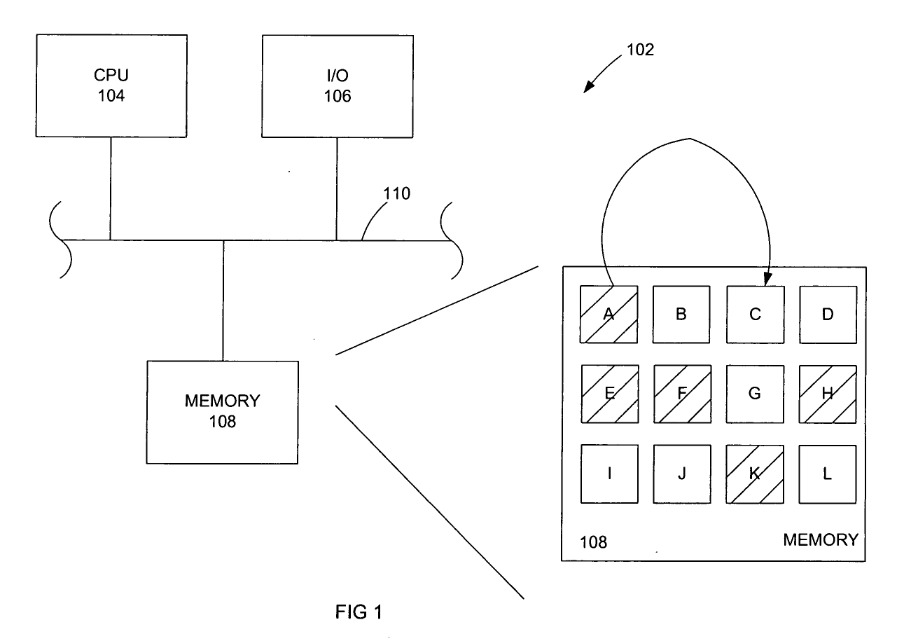

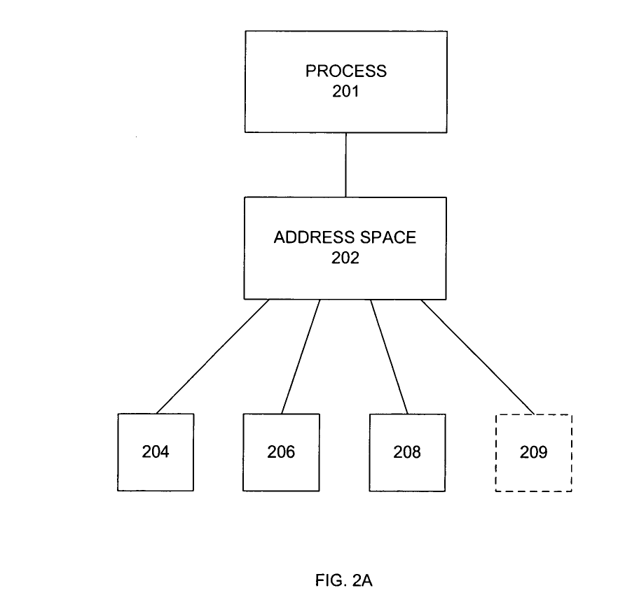

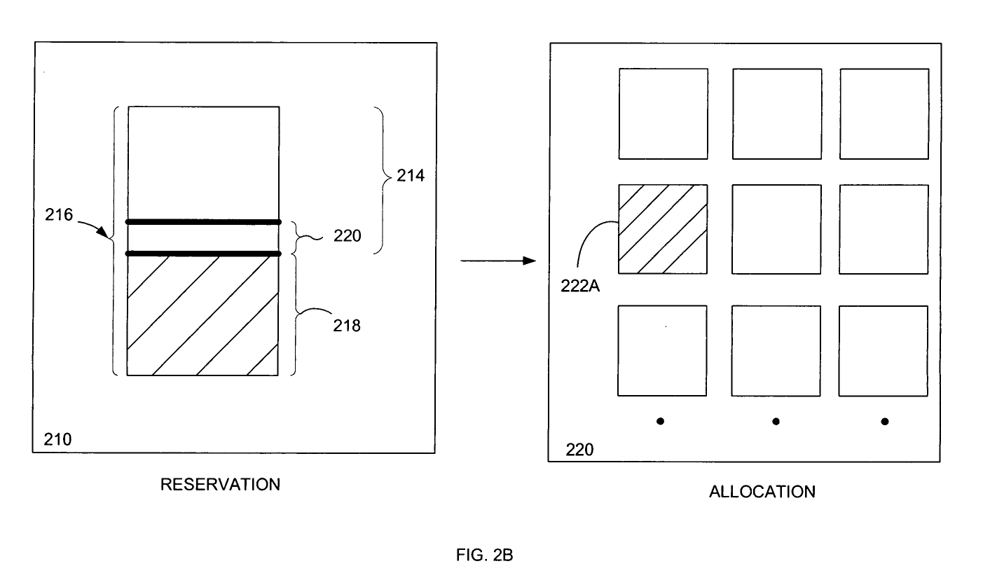

With respect to memory allocation, some computer systems allocate memory to a process (whether a user process or a kernel process) using two distinct phases: a reservation phase and an allocation phase. With respect to example FIG. 2A, there is shown an address space 202, which is associated with an example application process 201. Currently, application process 201 employs three memory pages 204, 206, and 208. At a given point in time, application (or user) process 201 wishes to obtain more memory in the form of a needed memory page 209.

FIG. 2B is a logical diagram of the reservation phase and the allocation phase as they pertain to fulfilling requests for additional memory. To obtain memory page 209, a reservation phase 210 first ascertains whether there exists a sufficient quantity of memory in the free memory pool of the computer system to accommodate the request for additional memory. Reference number 214 in FIG. 2 shows the free memory pool available from total memory 216. A memory amount 218 represents the memory already utilized from total memory 216. Since there is sufficient free memory in the example of FIG. 2 to accommodate the request for additional memory, reservation phase 210 reserves a memory chunk 220 out of the free memory pool 214, in effect earmarking an additional quantity of memory for use by application process 201.

The allocation phase 220 then selects a free memory page 222A from the free pool of memory 214 to allocate to application process 201. After allocation takes place, application process 201 may employ the newly allocated memory for its memory needs.

Note that existing memory allocation schemes make no distinction between floating memory and base memory during reservation phase 212. Accordingly, the reservation phase provides only information regarding whether a chunk of free memory having the requisite size is available. Currently, the reservation phase neither checks the requesting entity to ascertain which type of memory should be reserved (e.g., base versus floating) nor can the reservation phase provide information regarding the availability of a specific type of memory.

Consider the following scenario. If the requesting entity had been a kernel process instead of application process 201, the memory to be reserved (and subsequently allocated) should have been base memory to prevent an undesired evacuation in the future. This is because base memory, as mentioned earlier, is not subject to memory evacuation operations. If there is no free base memory available but there is plenty of free floating memory, the reservation phase would, however, still indicate that there is “free memory” available to service the request of the requesting kernel process. Based on the determination made by the reservation phase, floating memory may be erroneously allocated to the kernel process during the allocation phase. This is a similar risk to that discussed earlier.

However, there exists another mechanism in certain computer systems that governs the total amount of memory a process may use. This mechanism pertains to the creation of memory resource groups and memory classes. In the aforementioned patent applications entitled “Physical Memory Control Using Memory Classes” and “Managing Shared Memory Usage within a Memory Resource Group Infrastructure,” the concept of memory class and its relationship with memory resource groups have been described.

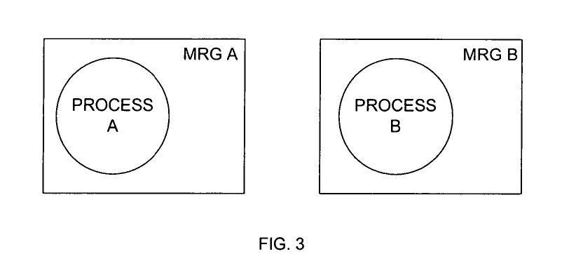

Generally speaking, in memory resource grouping, the physical memory is partitioned into logical blocks called memory resource groups, or MRGs. Application or user processes may be assigned to one or more user memory resource groups. In dividing the physical memory space into MRGs, the memory utilization of processes associated with one MRG does not impact the memory utilization in another MRG. With reference to FIG. 3, suppose, for example that a process A is assigned to a MRG A, and a process B is assigned to a MRG B. MRG A are assigned a given size, and MRG B is also assigned another given size. Even if a processes A requires a vast amount of memory and thus a lot of paging activities needs to be performed with respect to the memory assigned to MRG A, the amount of memory available to MRG B is not affected. Thus memory resource grouping is a way to provide memory isolation to a set of processes. Kernel processes may similarly be assigned to one or more kernel memory resource groups.

A memory class represents a logical container construct for one or more memory resource groups having the same memory type. Accordingly, there may exist a kernel memory class for one or more kernel memory resource groups, a user memory class for one or more user memory resource groups, and a system class for one or more system memory resource groups. A memory class can have a given size. Since it is possible to increase the size of a memory resource group if there is memory available, the use of a memory class, which serves as a logical container construct for one or more memory resource groups, provides a mechanism for preventing one or more memory resource groups of a given memory type from undesirably expanding beyond a predefined amount of memory, i.e., the size of the memory class.

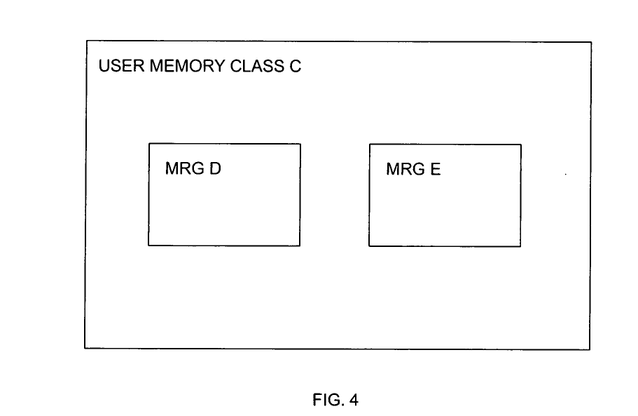

With reference to FIG. 4, for example, a user memory class C may have two user memory resource groups D and E. Even if user processes in memory resource groups D and E require vast amounts of memory, the amount of memory granted to these user processes and their associated user memory resource groups cannot exceed the amount of memory specified for the user memory class C. Accordingly, the use of the user memory class C insures that the maximum amount of user memory that can be allocated to the user processes associated with that user memory class C is the size of user memory class C. If the size of user memory class C is chosen appropriately, the kernel will not be starved of memory even if user processes require vast amounts of memory during execution.

It is realized by the inventors herein that these two aforementioned mechanisms may be employed to advantage to efficiently ensure that kernel processes will not be assigned floating memory during execution. If the additional memory request from a kernel process can be evaluated at the reservation stage such that allocation will occur only if there is sufficient base memory, embodiments of the invention can ensure that floating memory will not be allocated to the requesting kernel process. If there is insufficient base memory to fulfill the additional memory request from the kernel process, embodiments of the invention advantageously do not incur the overhead associated with the allocation phase since the request is terminated at the reservation phase.

It is also realized by the inventor that the base memory amount set by the operator upon configuring a computer system represents a highly useful parameter for setting the kernel class size. Since the reservation phase does not permit a kernel process to reserve additional memory if the reservation of additional memory would exceed the kernel class size, it is realized that if the kernel class size is set to less than or equal to the amount of base memory set by the operator, embodiments of the invention ensure that a reservation of additional memory by a kernel process would be permitted only if the resultant memory usage by the kernel as a class would not exceed the amount of base memory set.

On the other hand, if a reservation of additional memory by a kernel process would cause the resultant memory usage by the kernel as a class to exceed the kernel class size, reservation is not permitted. Since the kernel class size is not allowed to exceed the amount of base memory set, a reservation of additional memory by a kernel process that would cause the resultant memory usage by the kernel as a class to exceed the base memory size would not be possible.

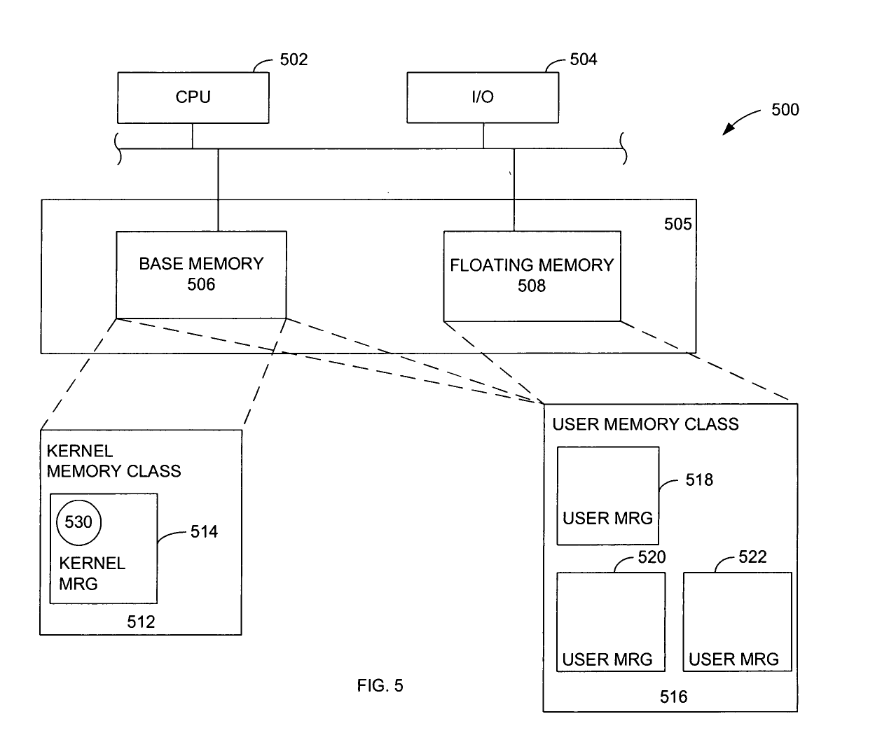

FIG. 5 shows, in accordance with an embodiment of the present invention, a block logic diagram of an example computer system in which the kernel process is constrained such that additional memory requests cannot be granted if such additional memory request by a kernel process would cause the resultant memory usage by the kernel to exceed the amount of base memory set. Computer 500 is shown having a CPU 502, an I/O module 504, and a memory 505, all connected via bus 510. Memory 505 is shown partitioned into base memory 506 and floating memory 508. Although multiple CPUs, I/O modules, memory modules, and other modules may be provided for a given computer, FIG. 5 is simplified to facilitate discussion. Further, a bus-based architecture is not always required, nor are the modules and CPUs need to co-locate in a single chassis.

A user memory class 516, representing the logical container for user memory resource groups 518, 520, and 522, is shown. Each of user memory resource groups 518, 520, and 522 may be associated with one or more user processes. In the example of FIG. 5, user memory class 516 may be associated with both base memory 506 and floating memory 508 although the association with base memory 506 is not required in all cases.

In contrast, a kernel memory class 512 is associated only with base memory 506. In other words, the size of kernel memory class 512 is set to be less than or equal to the size of base memory 506. As such, a kernel process 530 in a kernel memory resource group 514 in kernel memory class 512 is prevented from being able to reserve additional memory if such reservation would result in the total amount of memory usage by the kernel to exceed the size of kernel memory class 512 (which, as mentioned, is set to be less than or equal to the base memory amount 506). As such, embodiments of the invention ensure that any additional memory reservation (and subsequent allocation) by and for a kernel process would be made out of base memory and would not be subject to evacuation.

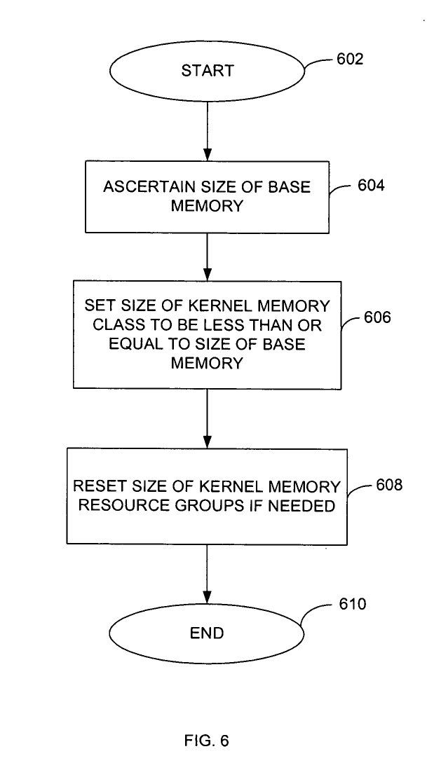

FIG. 6 shows, in accordance with an embodiment of the present invention, a method 600 for configuring the computer system such that the kernel process is prevented from being allocated floating memory. In step 602, the process starts. In step 604, the amount of base memory set by the operator is ascertained. In step 606, the kernel memory class is adjusted to be less than or equal (as desired) to the size of the base memory ascertained in step 604. In step 608, the size of the kernel memory resource group may be adjusted, if necessary, to ensure that the size of the kernel memory class is less than or equal to the size of the base memory. The process ends at step 610.

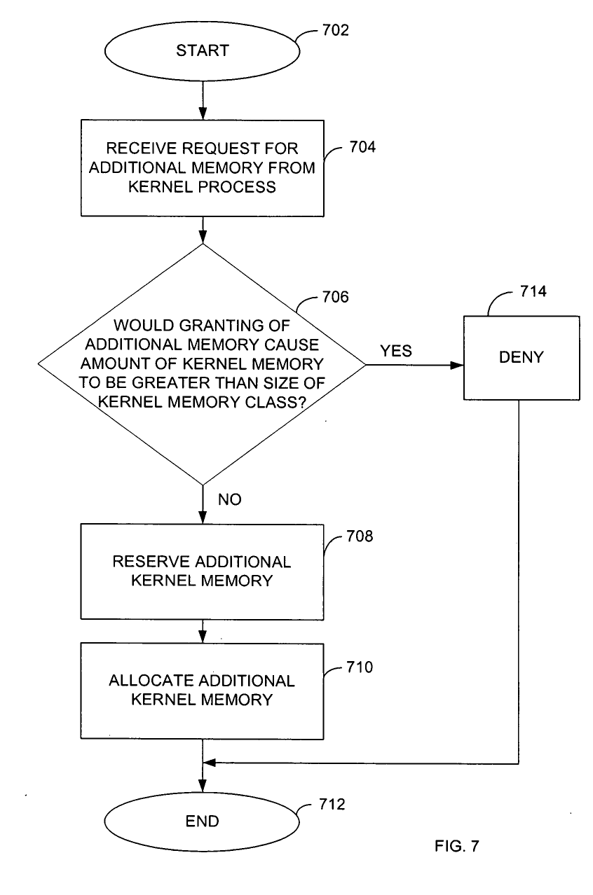

FIG. 7 shows, in accordance with an embodiment of the present invention, the steps taken to ensure that a kernel process is not granted floating memory in response to a request for additional kernel memory. From start (702), a request for additional memory is received from a kernel process (704). In step 706, it is ascertained whether the granting of additional memory to the kernel process in response to the request for additional kernel memory would cause the total amount of memory used by kernel processes to exceed the size of the kernel memory class. If so, the request for additional kernel memory is denied in step 714 and the process ends (712).

On the other hand, if the granting of additional memory to the kernel process in response to the request for additional kernel memory would not cause the total amount of memory used by kernel processes to exceed the size of the kernel memory class, the additional kernel memory is reserved in step 708. Thereafter, the additional kernel memory is allocated in step 710. The process ends in step 712.

As can be appreciated from the foregoing, embodiments of the invention leverages on existing mechanisms, such as base memory, memory resource classes and the reservation phase, to accomplish the goal of ensuring that additional kernel memory cannot be reserved unless base memory is available to service the request for additional kernel memory. This is so even though each of these existing mechanisms exist for a different purpose. Advantageously, little additional coding is required, and the implementation results in little additional complexity.

While this invention has been described in terms of several embodiments, there are alterations, permutations, and equivalents, which fall within the scope of this invention. For example, although embodiments of the invention are described as method steps, computer codes and/or specialized subsystems and/or circuits (both hard-wired and reprogrammable) that perform these steps or equivalent sub-steps that perform the disclosed functions are also intended to be part of the invention. The utilization of software code, hard-wired subsystems/circuits and/or reprogrammable systems/circuits to achieve the functions disclosed herein is within the skills of one skilled in the art given this disclosure. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A method for managing memory usage in a computer system having a kernel and a kernel memory class, comprising:
ascertaining a size of a base memory of said computer system, said base memory representing memory designated to be non-evacuable; and
setting a size of said kernel memory class to be no larger than said size of said base memory.

2. The method of claim 1 wherein said kernel memory class is associated with at least one kernel memory group.

3. The method of claim 1 further comprising:
receiving a request for additional memory by a kernel process;
ascertaining during a reservation phase whether said additional memory, if granted to said kernel process, would cause the amount of kernel memory usage by said kernel to exceed said size of said kernel memory class; and
proceeding to an allocation phase to allocate said additional memory only if said additional memory, if granted to said kernel process, would not cause the amount of kernel memory usage by said kernel to exceed said size of said kernel memory class.

4. The method of claim 3 further comprising:
resetting a memory size of a memory resource group associated with said kernel process if said additional memory, if granted to said kernel process, would not cause the amount of kernel memory usage by said kernel to exceed said size of said kernel memory class.

5. The method of claim 3 further comprising:
denying said request for said additional memory without proceeding to said allocation phase if said additional memory, if granted to said kernel process, would cause the amount of kernel memory usage by said kernel to exceed said size of said kernel memory class.

6. The method of claim 1 wherein said computer system represents a dynamically reconfigurable computer system.

7. The method of claim 6 wherein said size of said base memory is set by a human operator when said dynamically reconfigurable computer system is initially set up.

8. The method of claim 6 wherein said dynamically reconfigurable computer system employs a kernel memory class and at least one of an application memory class and a user memory class.

9. An article of manufacture comprising a program storage medium having computer readable code embodied therein, said computer readable code being configured to manage memory usage in a computer system having a kernel and a kernel memory class, comprising:
computer readable code for ascertaining a size of a base memory of said computer system, said base memory representing memory designated to be non-evacuable; and
computer readable code for setting a size of said kernel memory class to be no larger than said size of said base memory.

10. The article of manufacture of claim 9 wherein said kernel memory class is associated with at least one kernel memory group.

11. The article of manufacture of claim 9 further comprising:
computer readable code for receiving a request for additional memory by a kernel process;
computer readable code for ascertaining during a reservation phase whether said additional memory, if granted to said kernel process, would cause the amount of kernel memory usage by said kernel to exceed said size of said kernel memory class; and
computer readable code for allocating said additional memory only if said additional memory, if granted to said kernel process, would not cause the amount of kernel memory usage by said kernel to exceed said size of said kernel memory class.

12. The article of manufacture of claim 11 further comprising:
computer readable code for resetting a memory size of a memory resource group associated with said kernel process if said additional memory, if granted to said kernel process, would not cause the amount of kernel memory usage by said kernel to exceed said size of said kernel memory class.

13. The article of manufacture of claim 11 further comprising:
computer readable code for denying said request for said additional memory without proceeding to said allocation phase if said additional memory, if granted to said kernel process, would cause the amount of kernel memory usage by said kernel to exceed said size of said kernel memory class.

14. The article of manufacture of claim 9 wherein said computer system represents a dynamically reconfigurable computer system.

15. The article of manufacture of claim 14 wherein said size of said base memory is set by a human operator when said dynamically reconfigurable computer system is initially set up.

16. The article of manufacture of claim 14 wherein said dynamically reconfigurable computer system employs a kernel memory class and at least one of an application memory class and a user memory class to manage the memory space of said dynamically reconfigurable computer system.

17. An arrangement for managing memory usage in a dynamically reconfigurable computer system having a kernel and a kernel memory class, comprising:
means for ascertaining a size of a base memory of said computer system, said base memory representing memory designated to be non-evacuable;
means for setting a size of said kernel memory class to be no larger than said size of said base memory; and
means for granting additional memory to a kernel process that requests said additional memory if said additional memory, if granted to said kernel process, would not cause the amount of kernel memory usage by said kernel to exceed said size of said kernel memory class.

18. The arrangement of claim 17 further comprising:
means for denying at a reservation phase said request for said additional memory if said additional memory, if granted to said kernel process, would cause the amount of kernel memory usage by said kernel to exceed said size of said kernel memory class.

19. The arrangement of claim 17 further comprising:
means for resetting a memory size of a memory resource group associated with said kernel process if said additional memory, if granted to said kernel process, would not cause the amount of kernel memory usage by said kernel to exceed said size of said kernel memory class.

20. The arrangement of claim 17 wherein said size of said base memory is set by a human operator when said dynamically reconfigurable computer system is initially set up.
